(19) United States
(12) Patent Application Publication
(10) Pub. No.: US 2019/0113117 A1
(43) Pub. Date: Apr. 18, 2019

(54) Roller Screw Structure and Mechanism Thereof

(71) Applicant: Tzu-Ching Hung, Kaohsiung (TW)

(72) Inventor: Tzu-Ching Hung, Kaohsiung (TW)

(21) Appl. No.: 15/784,219

(22) Filed: Oct. 16, 2017

(51) Int. Cl. F16H 25/22; F16H 57/04

(52) U.S. Cl. CPC F16H 25/2252; F16H 57/0497

(57) ABSTRACT

A roller screw structure includes a screw rod, a nut set and planetary rollers. The screw rod includes an outer thread portion having first and second side-recession portions. The nut set includes an inner thread portion having third and fourth side-recession portions. The planetary roller includes a roller-thread portion having first and second side-protrusion portions. In assembling, the first and second side-protrusion portions are tightly engaged with the first and second side-recession portions, with the first and second side-protrusion portions tightly engaging with the third and fourth side-recession portions synchronously.

### BACKGROUND OF THE INVENTION

### 1. Field of the Invention

The present invention relates to a roller screw structure and mechanism thereof. Particularly, the present invention relates to the roller screw structure and mechanism thereof having a tight-fit relationship.

### 2. Description of the Related Art

U.S. Patent Application Publication No. 20140378271, entitled “Planet for a Planetary Rolling-contact Screw,” discloses a planetary rolling-contact screw. A planet for a planetary rolling contact gear includes a middle section and end sections along whose planetary axis. The middle section has a larger diameter and the end section has a smaller diameter. A first engagement profile is formed on the lateral surface of the planet in the middle section and a second engagement profile is formed on the lateral surface of the planet in the end sections. The first engagement profile has a plurality of first teeth that are arranged in an annular manner around the planetary axis. First grooves arranged in an annular manner about the planet axis are formed between successive first teeth. The two first edge teeth located at the ends of the middle section are formed within and at a distance from a tooth contour of the first teeth of the middle section.

U.S. Pat. No. 9,194,470, entitled “Nut of a Planetary Roller Screw Drive, and Method for Producing Such a Nut,” discloses a planetary roller screw drive. The planetary roller screw drive include a nut, a sleeve produced by metal forming, and two rings that lie at a fixed distance with respect to each other in the axial direction provided in this sleeve. In order to engage planets, the one ring has one groove profile and the other ring has the other groove profile.

U.S. Pat. No. 8,943,920, entitled “Roller Screw,” discloses a roller screw mechanism. The roller screw mechanism includes a screw comprising an external thread, a nut comprising an internal thread and coaxial with the screw, and rollers comprising flanks interacting with the threads and interposed between the screw and the nut. The value of the opening angle of the flanks of the external thread of the screw is greater than the value of the opening angle of the flanks of the rollers.

However, there is a need of improving and simplifying a conventional roller screw structure.

### SUMMARY OF THE INVENTION

The primary objective of this invention is to provide a roller screw structure and mechanism thereof. Advantageously, the present invention is successful in improving the entire structure with a tight-fit relationship, increasing operational smoothness and lowering operational noise.

The roller screw structure in accordance with an aspect includes:

a screw rod including an outer thread portion which has a first side-recession portion and a second side-recession portion;

a nut set including an inner thread portion which has a third side-recession portion and a fourth side-recession portion; and

at least one planetary roller including a roller-thread portion which has a first side-protrusion portion and a second side-protrusion portion;

wherein, in assembling, the first and second side-protrusion portions are tightly engaged with the first and second side-recession portions, with tightly engaging the first and second side-protrusion portions with the third and fourth side-recession portions synchronously.

The roller screw structure in accordance with an aspect includes:

a screw rod including an outer thread portion which has a first side-recession portion and a second side-recession portion;

a nut set including an inner thread portion; and

at least one planetary roller including a roller-thread portion which has a first side-protrusion portion and a second side-protrusion portion;

wherein, in assembling, the first and second side-protrusion portions are tightly engaged with the first and second side-recession portions, with tightly engaging the first and second side-protrusion portions with the inner thread portion synchronously.

The roller screw structure in accordance with an aspect includes: a screw rod including an outer thread portion;

a nut set including an inner thread portion which has a first side-recession portion and a second side-recession portion; and

at least one planetary roller including a roller-thread portion which has a first side-protrusion portion and a second side-protrusion portion;

wherein, in assembling, the first and second side-protrusion portions are tightly engaged with the outer thread portion, with tightly engaging the first and second side-protrusion portions with the first and second side-recession portions synchronously.

In a separate aspect, the first side-recession portion and the second side-recession portion have a first recession angle while the first side-protrusion portion and the second side-protrusion portion have a protrusion angle, with forming the protrusion angle smaller than the first recession angle.

In a further separate aspect, the third side-recession portion and the fourth side-recession portion have a second recession angle while the first side-protrusion portion and the second side-protrusion portion have a protrusion angle, with forming the protrusion angle smaller than the second recession angle.

In yet a further separate aspect, the outer thread portion has a first thread reference line and a second thread reference line between which define a first thread angle, with the inner thread portion having a third thread reference line and a fourth thread reference line between which define a second thread angle, with the roller-thread portion having a fifth thread reference line and a sixth thread reference line between which define a third thread angle, with forming at least one of the first thread angle and the second thread angle identical with or smaller than the third thread angle.

In yet a further separate aspect, the first, second, third, fourth side-recession portions include a plurality of thermal-treated layers.

In yet a further separate aspect, the first, second side-protrusion portions include a plurality of thermal-treated layers.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of a roller screw mechanism in accordance with an embodiment of the present invention.

FIG. 2 is a partial cutaway view of the roller screw mechanism in accordance with the embodiment of the present invention.

FIG. 3 is a partially enlarged view of a roller screw structure in accordance with the embodiment of the present invention.

FIG. 4 is a partially enlarged perspective view of a roller-thread portion in accordance with the embodiment of the present invention.

FIG. 5 is a partially enlarged view of an outer thread portion of a screw rod in accordance with a first embodiment of the present invention.

FIG. 6 is a partially enlarged view of the outer thread portion of the screw rod tightly engaged with a roller-thread portion of a planetary roller in accordance with the first embodiment of the present invention.

FIG. 7 is a partially enlarged view of an inner thread portion of a nut set in accordance with a second embodiment of the present invention.

FIG. 8 is a partially enlarged view of the inner thread portion of the nut set tightly engaged with the roller-thread portion in accordance with the second embodiment of the present invention.

### DETAILED DESCRIPTION OF THE INVENTION

It is noted that a roller screw structure and mechanism thereof in accordance with the present invention can be applicable for various planetary roller screws, gothic roller screws, for example, which are not limitative of the present invention.

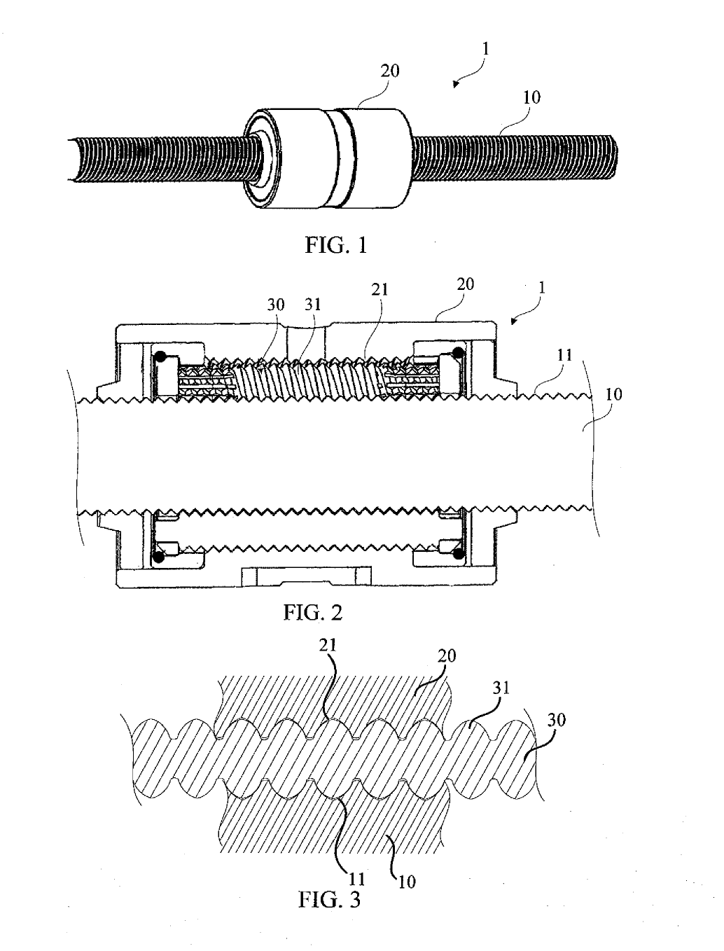

Referring now to FIGS. 1 and 2, the roller screw mechanism in accordance with an embodiment of the present invention includes a screw rod 10, a nut set 20 and a plurality of planetary rollers 30 which are assembled to form a planetary roller screw structure.

Turning now to FIGS. 2 and 3, in assembling, the screw rod 10 extends along a longitudinal axis through the nut set 20 coaxially. The planetary rollers 30 are equi-spaced around the screw rod 10 and interposed between the screw rod 10 and the nut set 20.

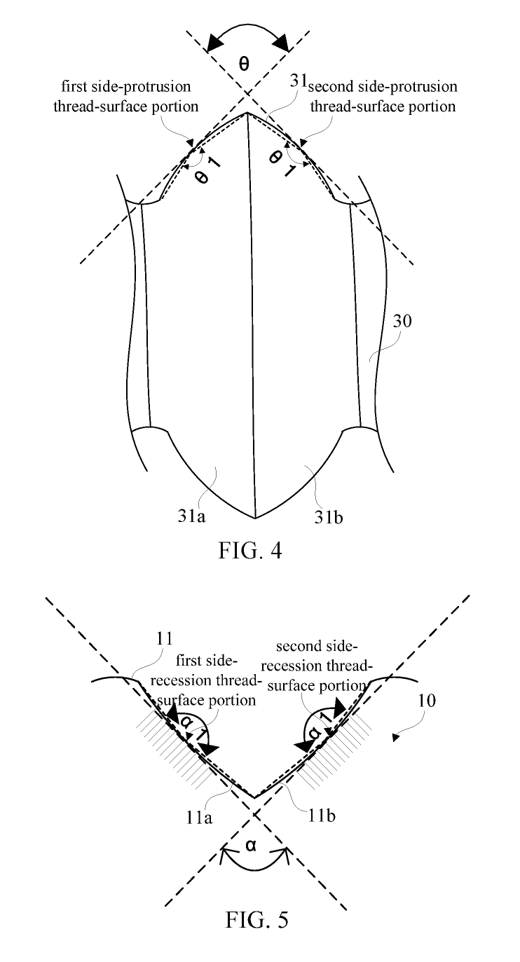

Turning now to FIGS. 2, 3 and 4, in the first embodiment, each planetary roller 30 includes a roller-thread portion 31 which has a first side-protrusion portion and a second side-protrusion portion. The first side-protrusion portion and the second side-protrusion portion have a protrusion-surface angle θ1. Each side-protrusion portion includes at least one or a plurality of thermal-treated layers with increasing or decreasing thicknesses to strengthen the hardness of protrusion surface. With respect to the thermal-treated layers, the first side-protrusion portion has a topmost of protrusion while the second side-protrusion portion have has an opposite topmost of protrusion.

With continued reference to FIGS. 2, 3 and 4, the roller-thread portion 31 includes a first side-curved surface 31a having a thread reference line and a second side-curved surface 31b having a thread reference line. The two thread reference lines define a thread angle θ (90°±5) therebetween.

Turning now to FIGS. 2, 3 and 5, the screw rod 10 includes an outer thread portion 11 which has a first side-recession portion and a second side-recession portion. The first side-recession portion and the second side-recession portion have a recession-surface angle α1. Each side-recession portion includes at least one or a plurality of thermal-treated layers (section lines) with increasing or decreasing thicknesses to strengthen the hardness of recession surface. With respect to the thermal-treated layers, the first side-recession portion has a lowermost of recession while the second side-recession portion have has an opposite lowermost of recession. In assembling, the topmost of the first side-protrusion portion engages with the lowermost of the first side-recession portion and the topmost of the second side-protrusion portion engages with the lowermost of the second side-recession portion.

With continued reference to FIGS. 2, 3 and 5, the outer thread portion 11 includes a first side-curved surface 11a formed on the first side-recession portion and having a thread reference line. The outer thread portion 11 further includes a second side-curved surface 11b formed on the second side-recession portion and having a thread reference line. The two thread reference lines define a thread angle α therebetween.

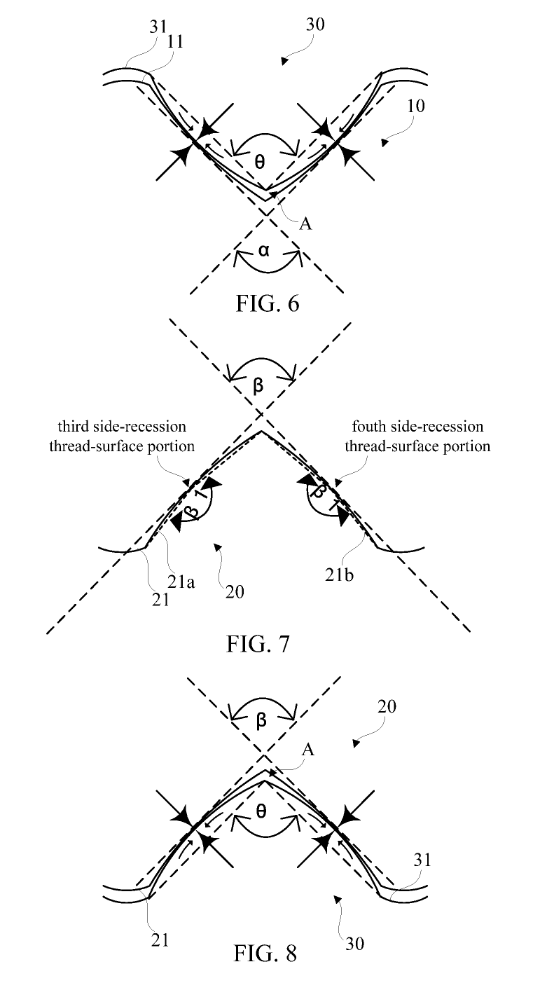

Referring to FIGS. 2-6, in assembling, the first and second side-protrusion portions of the roller-thread portion 31 are tightly engaged with the first and second side-recession portions of the outer thread portion 11, indicated at the left and right arrows in FIG. 6. In another embodiment, the first and second side-protrusion portions of the roller-thread portion 31 are tightly engaged with two thread flat surfaces of the nut set 20 synchronously.

An end edge of the first side-curved surface 11a connects with that of the second side-curved surface 11b has a lubricant circulation channel “A” defined by the combination of first side-curved surface 31a with second side-curved surface 31b, thereby increasing operational smoothness and lowering operational noise. The protrusion-surface angle θ1 is smaller than the recession-surface angle α1 such that, in operation, the first and second side-protrusion portions can slide along the first and second side-recession portions, indicated at the curved arrows in FIG. 6.

Referring now to FIGS. 2, 3 and 7, in the second embodiment, the nut set 20 include an inner thread portion 21 which has a third side-recession portion and a fourth side-recession portion. The third side-recession portion and the fourth side-recession portion have a recession-surface angle β1. Each side-recession portion includes at least one or a plurality of thermal-treated layers with increasing or decreasing thicknesses to strengthen the hardness of recession surface. With respect to the thermal-treated layers, the third side-recession portion has a lowermost of recession while the fourth side-recession portion have has an opposite lowermost of recession. In assembling, the topmost of the first side-protrusion portion engages with the lowermost of the third side-recession portion and the topmost of the second side-protrusion portion engages with the lowermost of the fourth side-recession portion.

With continued reference to FIGS. 2, 3 and 7, the inner thread portion includes a third side-curved surface 21a formed on the third side-recession portion and having a thread reference line. The inner thread portion 21 further includes a fourth side-curved surface 21b formed on the second side-recession portion and having a thread reference line. The two thread reference lines define a thread angle β therebetween.

Referring to FIGS. 2, 3, 4, 7 and 8, in assembling, the first and second side-protrusion portions of the roller-thread portion 31 are tightly engaged with the third and fourth side-recession portions of the inner thread portion 21, indicated at the left and right arrows in FIG. 8. In another embodiment, the first and second side-protrusion portions of the roller-thread portion 31 are tightly engaged with two thread flat surfaces of the screw rod 10 synchronously.

An end edge of the third side-curved surface 21a connects with that of the fourth side-curved surface 21b has a lubricant circulation channel “A” defined by the combination of first side-curved surface 31a with second side-curved surface 31b, thereby increasing operational smoothness and lowering operational noise. The protrusion-surface angle θ1 is smaller than the recession-surface angle β1 such that, in operation, the first and second side-protrusion portions can slide along the third and fourth side-recession portions, indicated at the curved arrows in FIG. 8.

In another embodiment, one or both of the first thread angle α and the second thread angle β are identical with or smaller than the third thread angle θ in order to expand the lubricant circulation channel.

Although the invention has been described in detail with reference to its presently preferred embodiment, it will be understood by one of ordinary skill in the art that various modifications can be made without departing from the spirit and the scope of the invention, as set forth in the appended claims.

1. A roller screw structure comprising:
a screw rod including an outer thread portion which has a first side-recession thread-surface portion longitudinally extended on a first outer thread side surface of the outer thread portion and a second side-recession thread-surface portion longitudinally extended on a second outer thread side surface of the outer thread portion;
a nut set including an inner thread portion which has a third side-recession thread-surface portion longitudinally extended on a third inner thread side surface of the inner thread portion and a fourth side-recession thread-surface portion longitudinally extended on a fourth inner thread side surface of the inner thread portion; and
at least one planetary roller including a roller-thread portion which has a first side-protrusion thread-surface portion longitudinally extended on a first roller thread side surface of the roller-thread portion and a second side-protrusion portion longitudinally extended on a second roller thread side surface of the roller-thread portion;
wherein each of the first and second side-protrusion thread-surface portions of the roller-thread portion of the at least one planetary roller are tightly engaged with and received in each of the first and second side-recession thread-surface portions of the outer thread portion of the screw rod to form a first protrusion-recession engagement, and wherein each of the first and second side-protrusion thread-surface portions of the roller-thread portion of the at least one planetary roller are further tightly engaged with and received in each of the third and fourth side-recession thread-surface portions of the inner thread portion of the nut set to form a second protrusion-recession engagement.

2. The structure as defined in claim 1, wherein the first side-recession thread-surface portion and the second side-recession thread-surface portion of the outer thread portion of the screw rod have a first recession angle while and the first side-protrusion thread-surface portion and the second side-protrusion thread-surface portion of the roller-thread portion of the at least one planetary roller have a protrusion angle smaller than the first recession angle.

3. The structure as defined in claim 1, wherein the third side-recession thread-surface portion and the fourth side-recession thread-surface portion of the inner thread portion of the nut set have a second recession angle and the first side-protrusion thread-surface portion and the second side-protrusion thread-surface portion of the roller-thread portion of the at least one planetary roller have a protrusion angle smaller than the second recession angle.

4. The structure as defined in claim 1, wherein the outer thread portion has a first thread reference line and a second thread reference line between which define a first thread angle, with the inner thread portion having a third thread reference line and a fourth thread reference line between which define a second thread angle, with the roller-thread portion having a fifth thread reference line and a sixth thread reference line between which define a third thread angle, with at least one of the first thread angle and the second thread angle being identical with or smaller than the third thread angle.

5. The structure as defined in claim 1, wherein the first and second side-protrusion thread-surface portions or the first, second, third and fourth side-recession thread-surface portions include at least one thermal-treated layer.

6. A roller screw structure comprising:
a screw rod including an outer thread portion which has two side-recession thread-surface portions each of which longitudinally extends on an outer thread side surface of the outer thread portion;
a nut set including an inner thread portion; and
at least one planetary roller including a roller-thread portion which has two side-protrusion thread-surface portions each of which longitudinally extends on a roller thread side surface of the roller-thread portion;
wherein each of the two side-protrusion thread-surface portions of the roller-thread portion of the at least one planetary roller are tightly engaged with and received in each of the two side-recession thread-surface portions of the outer thread portion of the screw rod to form a protrusion-recession engagement, and wherein the two side-protrusion thread-surface portions of the roller-thread portion of the at least one planetary roller are further tightly engaged with the inner thread portion of the nut set.

7. The structure as defined in claim 6, wherein the two side-recession thread-surface portions of the outer thread portion of the screw rod have a first recession angle and the two side-protrusion thread-surface portions of the roller-thread portion of the at least one planetary roller have a protrusion angle smaller than the first recession angle.

8. The structure as defined in claim 6, wherein the outer thread portion has two thread reference lines between which define a first thread angle, with the roller-thread portion having two thread reference lines between which define a second thread angle, with the first thread angle being identical with or smaller than the second thread angle.

9. The structure as defined in claim 6, wherein the side-protrusion thread-surface portions or the side-recession thread-surface portions include at least one thermal-treated layer.

10. The structure as defined in claim 6, wherein a connection section of a two side-curved end surface of the outer thread portion of the screw rod has a lubricant circulation channel defined by a combination of a two side-curved end surface of the roller-thread portion of the at least one planetary roller.

11. A roller screw structure comprising:
a screw rod including an outer thread portion;
a nut set including an inner thread portion which has two side-recession thread-surface portions each of which longitudinally extends on an inner thread side surface of the inner thread portion; and
at least one planetary roller including a roller-thread portion which has two side-protrusion thread-surface portions each of which longitudinally extends on a roller thread side surface of the roller-thread portion;
wherein the two side-protrusion thread-surface portions of the roller-thread portion of the at least one planetary roller are tightly engaged with the outer thread portion of the screw rod, and wherein each of the two side-protrusion thread-surface portions of the roller-thread portion of the at least one planetary roller are further tightly engaged with and received in each of the two side-recession thread-surface portions of the inner thread portion of the nut set to form a protrusion-recession engagement. portion of the at least one planetary roller have a protrusion angle smaller than the first recession angle.

13. The structure as defined in claim 11, wherein the inner thread portion has two thread reference lines between which define a first thread angle, with the roller-thread portion having two thread reference lines between which define a second thread angle, with the first thread angle being identical with or smaller than the second thread angle.

14. The structure as defined in claim 11, wherein the two side-protrusion thread-surface portions or the two side-recession thread-surface portions include at least one thermal-treated layer.

15. The structure as defined in claim 11, wherein a connection section of a two side-curved surface end of the inner thread portion of the nut set has a lubricant circulation channel defined by a combination of a two side-curved surface end of the roller-thread portion of the at least one planetary roller.
